(19) United States
(12) Patent Application Publication
(10) Pub. No.: US 2003/0145472 A1
(43) Pub. Date: Aug. 7, 2003

(54) Reciprocating saw with flush cutting capability

(76) Inventor: Edgar Leon Swift, Roswell, GA (US)

Correspondence Address: EDGAR L. SWIFT, 1596 SANDPOINT DRIVE, ROSWELL, GA, 30075, US

(21) Appl. No.: 10/066,480

(22) Filed: Feb. 1, 2002

(51) Int. Cl. B23D 47/02

(52) U.S. Cl. 30/374

(57) ABSTRACT

An improved electrically powered reciprocating saw that is capable of cutting a workpiece flush with a surface positioned along a raised intersecting perpendicular plane. It also features a new blade actuator that enables the saw blade to be installed on either the left or the right side of the saw. Its new blade and shank assembly has an offset shank that allows the blade to be installed on either the left or the right side of the saw, thus enabling the saw to make cuts beyond the plane of either the left side or the right side of the saw.

### BACKGROUND

1. Field of the Invention

The present invention relates to reciprocating saws that operate cutting blades linearly along a plane horizontal to the longitudinal centerline of the body of the saw. It further discloses a new, offset shank saw blade, incorporating teeth on both its leading and trailing edges that enable the saw to efficiently cut a workpiece flush with a surface positioned along a raised intersecting perpendicular plane. This application further discloses a blade actuator that enables the saw to cut a workpiece flush up to a surface positioned in a raised intersecting perpendicular plane.

2. Description of the Prior Art

Electrically powered reciprocating saws are known to the prior art and are used by a variety of laypersons and tradesmen such as plumbers, electricians and carpenters for both new construction and remodeling of existing construction. Many of the applications require that the saw be capable of cutting a workpiece flush with or flush to a surface, such as a wall or the inside of a boxed-in area, that is raised perpendicularity in relation to the plane of the workpiece that is being cut. Various successful efforts have been put forth towards making the conventional reciprocating saw more versatile, such as incorporating easier to change blades, “pivoting” shoes, angle-cutting capability, battery power, etc. However, the design of a flush-cutting reciprocating saw, such a the type aforedescribed, has not been forthcoming, possibly because such a design has been nonobvious to the practicioners of the prior art.

The main impediment that has precluded conventional reciprocating saws from being able to cut a workpiece flush with or flush to a raised perpendicular surface has to do with the location of the saw's blade in respect to the body of the saw and its shoe. The cutting teeth of the blade of conventional reciprocating saws is usually located in or adjacent the plane of the longitudinal centerline of the saw and its shoe. How close such a saw can cut a workpiece along a surface located in a raised, intersecting perpendicular plane is determined by roughly one-half the width of either the body of the saw, or its shoe, whichever is wider. How close such a saw can cut a workpiece up to a surface located in a raised, intersecting perpendicular plane is determined by how far the plane of the saw blade's cutting teeth lie below the horizontal plane of the top of the saw's body and other embodiments, such as the shoe, shield, etc. Some of the shoes of such saws have been designed to pivot or to be moved longitudinally along the plane of the centerline of the saw, but none that I have researched allow them to be positioned so that they will not obstruct flush cutting. The design of the saw blades used in such saws are also not conducive to flush cutting in the manner aforedescribed.

The prior art is crowded with examples of reciprocating saws incorporating the above limitations. Some examples are shown in the following U.S. Pat. Nos. 5,940,977 to Moores, Jr., dated Aug. 24, 1999; 5,855,070 to Grabowski, dated Jan. 5, 1999; 6,272,757 B1 to Roe, dated Aug. 14, 2001; 5,724,741 to Bednar, dated Mar. 10, 1998 and 6,233,833 B1 to Grant, et al, dated May 22, 2001. Copies of these patents and others, along with my IDS, are attached to this application.

Reciprocating saw blades that have teeth on both their leading and trailing edges are also known in the prior art. None of those that I have researched have claimed this feature as a means of enabling the saw to be used for cutting while it is being both pushed into the workpiece or being pulled into or across the workpiece, nor have they claimed such a design as enabling a user to use the saw to make flush cuts along a raised surface positioned in an intersecting perpendicular plane on either side of the waw without needing to switch to a different blade. This may be because a saw designed to take advantage of such capability had not yet been conceived because it was apparently nonobvious to the practicioners of the prior art. Some U.S. patents of the prior art that disclose “double-edged” saw blades are as follows: D448634 to Hickman, dated Oct. 2, 2001, which incorporates a fine-pitch row of teeth on one edge of the blade and a course-pitch row of teeth on the opposing edge of the blade. It was clearly invented to have one blade serve two different cutting purposes. Another invention related to such a design is U.S. Pat. No. 5,517,889 to logan, dated May 21, 1996. The claims of this invention are slanted towards its being a blade that can be used to start a cut without a pilot hole. Patent D427865 awarded to Mills, Jr., dated Jul. 11, 2000 is quite similar to the invention just mentioned and makes no claims concerning its utilitarian function. I have been unable to discover a double-cutting-edge reciprocating saw blade that has an offset shank that will enable flush cutting in the manner described. A single-cutting-edge blade with an offset shank has been presented by me in my application Ser. No. 10/05630, dated Dec. 5, 2001, unaware that the idea had already been thought of and disclosed in U.S. Pat. No. 4,566,190 to Isakson, dated Jan. 28, 1986. Both inventions apply to saber saws with vertically reciprocating blades, rather than saws with horizontally reciprocating as is being presented. I don't believe that they obviously relate to the present invention, because the design problems that must be overcome are quite unique. I determined from my own experience with a prototype of such a blade that the blade is susceptible to stress hardening at the area where the blade is formed into an “S” curve to effect the offset in the shank and, is, consequently subject to premature fracture.

U.S. Pat. No. 4,553,306, issued Nov. 19, 1985 to Mineck is of a Reciprocating Saw Offset Blade Holder and appears to be capable of making nearly flush cuts, but is impeded from making completely flush cuts by the design and positioning of its blade clamp 16 and mounting screw 27. The width of the saw's body would appear to prevent this saw from making “flush with” cuts along a tall perpendicular surface such as a wall, since the adapter does not position the blade beyond the plane of either side of the saw. A further limitation inherent in the design of this saw is that it doesn't incorporate a shoe that will provide stability for the saw during the initial stage of making a “flush to” cut starting at the edge of a workpiece. My experience with trying to cut a workpiece with such a saw without having a shoe to press against some part of the workpiece is that the saw blade jumps around uncontrollably, since the user's arm can not provide the necessary stability to hold the blade in place against the reciprocating action of the saw. A further limitation to the design of this saw is that its adapter is fit for mounting on only one side of the saw. This further limits its versatility in making flush cuts, since there are times when flush cuts may need to be made on either side of the saw.

### SUMMARY

With the foregoing discussions of the prior art reciprocating saws, their shoes and their blades in mind, my proposed flush-cutting reciprocating saw, which will be described subsequently in greater detail, is a new electrically powered reciprocating saw that enables its user to cut a workpiece flush with or flush to the surface of a raised perpendicular plane such as a wall or the inside of a boxed-in area. It also retains many of the advantages of prior art reciprocating saws and can, in fact, be used in place of them. It can be built with minimal modifications to conventional reciprocating saws that are currently available. The newly designed blade actuator, the forward handle, the adjustable shoe design and the offset shank sawblade of the present saw are key features that enable the cutting of a workpiece flush with or flush to a raised surface positioned in an intersecting perpendicular plane. Accordingly, besides the objects and advantages of my new flush-cutting reciprocating saw summarized above, several objects and advantages of this invention are:

### OBJECTS AND ADVANTAGES

(a) To provide a reciprocating saw that is capable of cutting a workpiece flush with or flush to a raised surface positioned in an intersecting perpendicular plane, such as a wall;

(b) to provide a flush-cutting reciprocating saw that is easy to use with little user training;

(c) to provide a flush-cutting reciprocating saw that can be built with minimal development and manufacturing costs by a manufacturer that currently makes conventional hand-held reciprocating saws;

(d) to provide a flush-cutting reciprocating saw that a manufacturer can market to its existing distribution channels with minimal training of its existing sales force.

Further objects and advantages will become apparent from a consideration of the ensuing drawings and detailed descriptions of the embodiments of this new flush-cutting reciprocating saw.

### DRAWINGS

FIG. 1 is an orthogonal side view of a conventional hand-held reciprocating power saw.

FIG. 2 is a view of a front section of the saw shown in FIG. 1 taken along line 2-2 of FIG. 1.

FIG. 3 is an orthogonal view of a flat side of the blade actuator of a conventional reciprocating saw.

FIG. 4 is an orthogonal view of the left side of the preferred embodiment of the present saw with the blade installed on the left side, and the leading surface of the shoe positioned above the plane of the top row of the blade's cutting teeth.

FIG. 5 is an orthogonal view of the top side of the blade actuator for the present saw.

FIG. 6 is an orthogonal exploded view of the left side of the shoe and bracket assembly of the preferred embodiment of the present saw.

FIG. 7 is an orthogonal view of the left side of the assembled shoe and bracket assembly for the preferred embodiment of the present saw.

FIG. 8 is an enlarged view of the shoe and bracket assembly for the preferred embodiment of the present saw taken along line 8-8 of FIG. 7.

FIG. 9 is an enlarged view of the shoe and bracket assembly for the preferred embodiment of the present saw taken along line 9-9 of FIG. 7.

FIG. 10 is an enlarged view of a front section of the present saw taken along line 10-10 of FIG. 4.

FIG. 11 is a magnified view of the section of the present saw defined by the dashed circle in FIG. 10.

FIG. 12 is an enlarged orthogonal view of one edge of a universal blade and shank assembly for the present saw.

FIG. 13 is an enlarged orthogonal view of one side of a universal blade and shank assembly for the present saw.

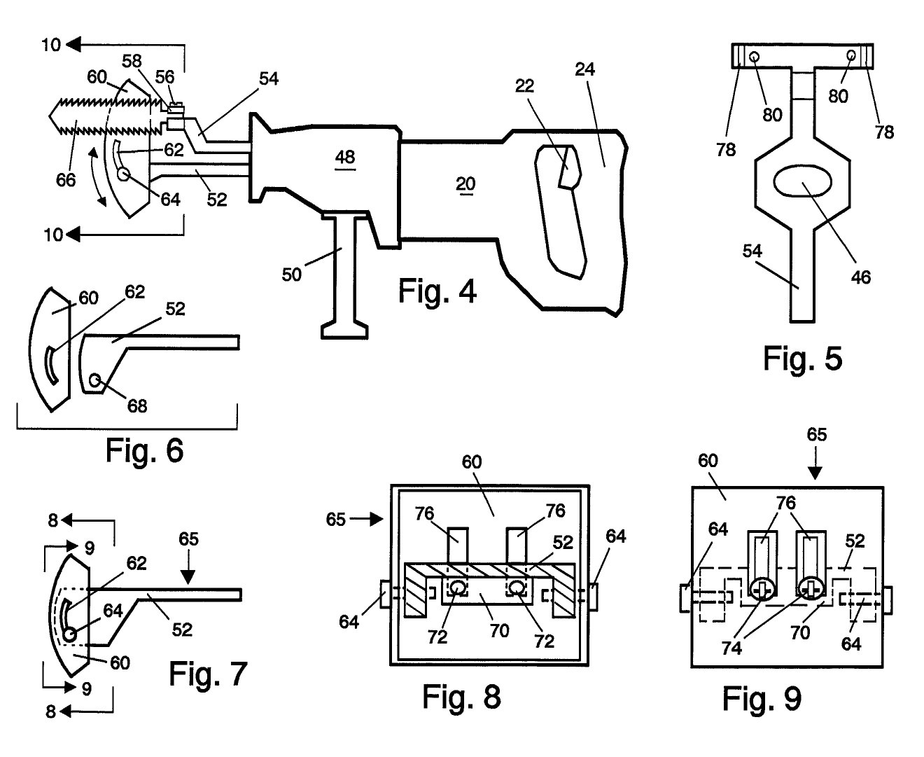

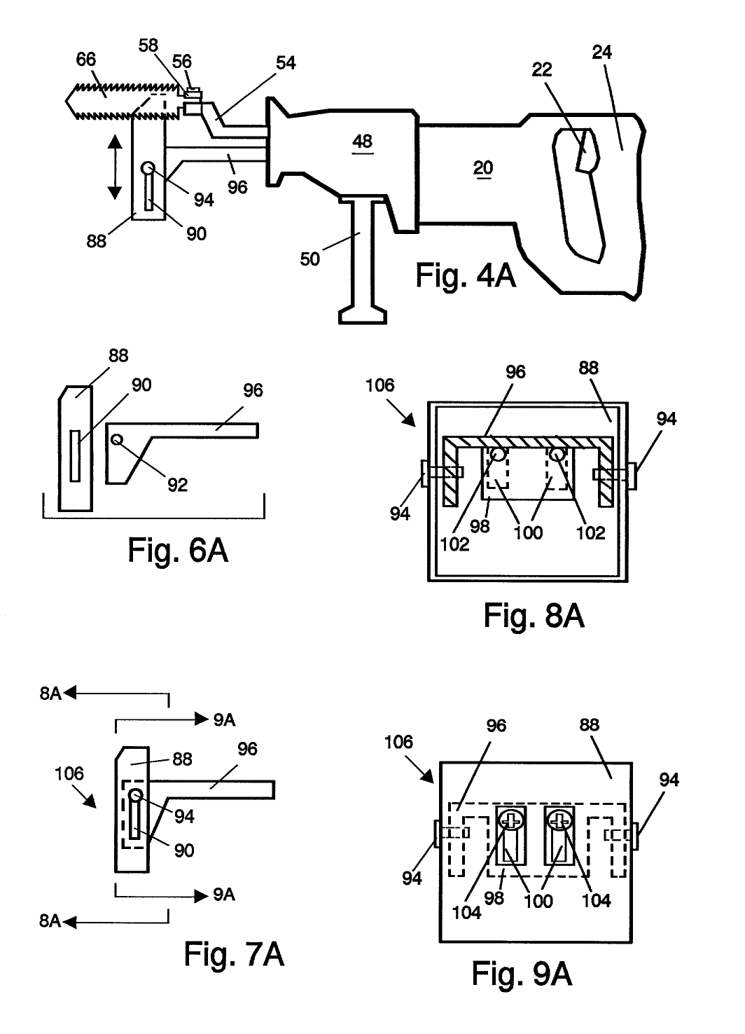

FIG. 4A is an orthogonal view of the left side of the alternate embodiment of the present saw with the blade installed on the left side, and the leading surface of the shoe positioned below the plane of the top row of the blade's cutting teeth.

FIG. 6A is an orthogonal view of the left side of the shoe and mounting bracket of the alternate embodiment of the present saw separated from each other.

FIG. 7A is an orthogonal view of the left side of the shoe and bracket assembly of the alternate embodiment of the present saw.

FIG. 8A is an enlarged view of the shoe and bracket assembly for the alternate embodiment of the present saw taken along line 17-17 of FIG. 7A.

FIG. 9A is an enlarged view of the shoe and bracket assembly for the alternate embodiment of the present saw taken along line 18-18 of FIG. 7A.

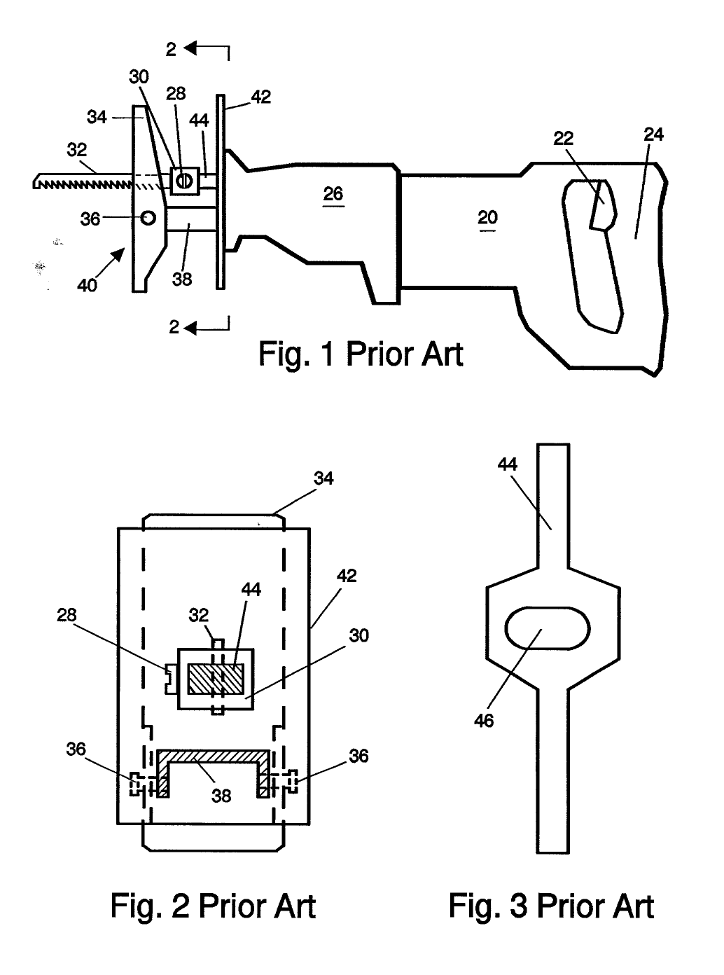

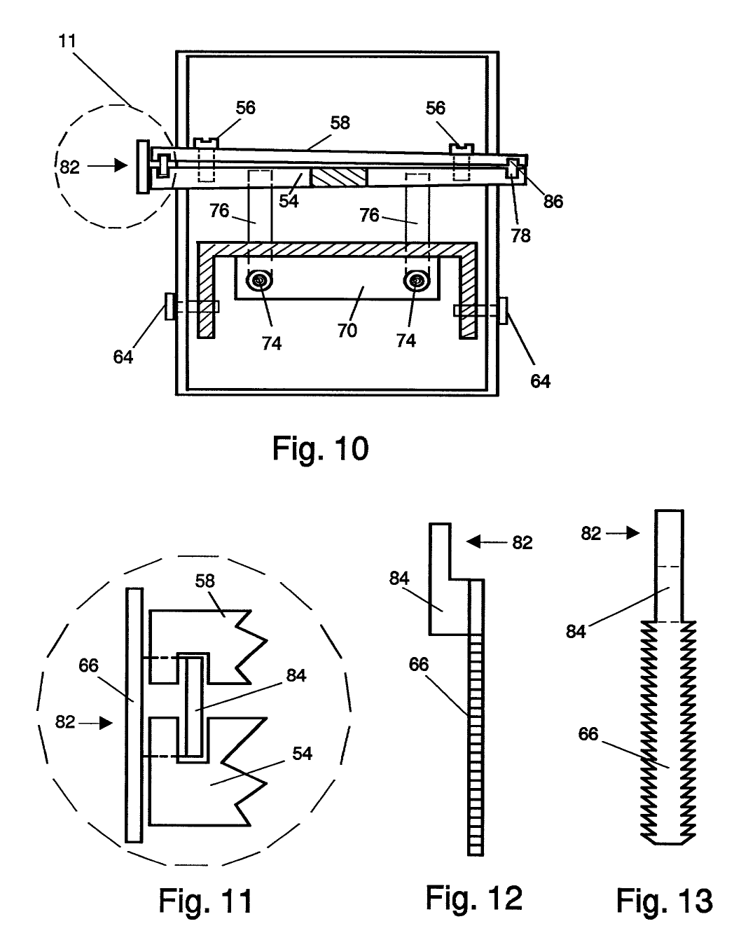

Reference Numerals In Drawings (*Denotes Prior Art)

| | | | |
|---|---|---|---|
| 2 | Fragmentary View Shown in FIG. 1* | 8 | Fragmentary View Shown in FIG. 7 |
| 8A | Fragmentary View Shown In FIG. 7A | 9 | Fragmentary View Shown In FIG. 7 |
| 9A | Fragmentary View Shown In FIG. 7A | 10 | Fragmentary View Shown In FIG. 4 |
| 11 | Magnified View Shown In FIG. 10 | 20 | Rear Housing* |
| 22 | Power Switch* | 24 | Rear Handle* |
| 26 | Forward Housing* | 28 | Blade Clamp Screw* |
| 30 | Blade Clamp* | 32 | Blade* |
| 34 | Shoe* | 36 | Show Pivot Stud* |
| 38 | Show Mounting Bracket* | 40 | Shoe And Bracket Assembly* |
| 42 | Shield* | 44 | Blade Actuator* |
| 46 | Cam Slot* | 48 | New Forward Housing |
| 50 | Forward Handle | 52 | New Shoe Mounting Bracket |
| 54 | New Blade Actuator | 56 | New Blade Clamp Screws (2) |
| 58 | New Universal Blade Clamp | 60 | New “Rocking Shoe” |
| 62 | Shoe Pivot Slots (2) | 64 | New Shoe Pivot Studs (2) |
| 65 | Shoe And Bracket Assembly | 66 | New Universal Blade |
| 68 | Pivot Stud Holes (2) | 70 | Shoe Locking Flange |
| 72 | Threaded Locking Holes (2) | 74 | Shoe Locking Screws (2) |
| 76 | Shoe Locking Slots (2) | 78 | Actuator Blade Grooves (2) |
| 80 | Threaded Mounting Holes (2) | 82 | Blade And Shank Assembly |
| 84 | Blade Shank | 86 | Clamp Blade Grooves (2) |
| 88 | Sliding Shoe | 90 | Shoe Sliding Slots (2) |
| 92 | Shoe Stud Mounting Holes (2) | 94 | Shoe Studs (2) |
| 96 | Shoe Bracket | 98 | Shoe Locking Flange |
| 100 | Shoe Locking Slots (2) | 102 | Threaded Locking Holes (2) |
| 104 | Shoe Locking Screws (2) | 106 | Shoe And Bracket Assembly |

### DESCRIPTIONS OF THE PREFERRED EMBODIMENT

Description—FIG. 1

FIG. 1 schematically shows a typical conventional hand-held reciprocating saw that will be used as the basis for the present saw. As a point of reference, this drawing resembles the RYOBI (TM) Model RJ160V. Reciprocating saws such as the one shown are typically about 18 inches long and have a rear handle 24, a finger operated power switch 22, a rear housing 20 that contains an electric motor (not shown) and a forward housing 26, which encloses the reciprocating mechanisms of the saw that convert the rotary motion of the saw's motor to linear motion at a blade 32. Such linear motion is in a plane parallel to that of the longitudinal centerline of the saw's housing. Since the forward housing 26 also serves as a handgrip, a shield 42 is usually also installed as a safety consideration. The conventional reciprocating saw shown in this figure also has a blade actuator 44 that has a clamp 30 on its end to receive the saw blade 32 that is secured into place using a blade clamp screw 28. A shoe 34 engages the workpiece during the cutting operation to provide stability for the saw. Ref. 40 generally refers to the shoe and bracket assembly, consisting of the shoe 34, the shoe mounting bracket 38 and shoe pivot stud 36. Ref. 2 relates to FIG. 2.

Description—FIG. 2

FIG. 2 is a fragmentary cross sectional view of a front portion of the saw taken along lines 2-2 of FIG. 1. It shows the inverted “U” design of the shoe mounting bracket 38 and how it is pivotably attached to the shoe 34 using a pivot stud 36 on each side. Although the blade actuator 44 in this view has a rectangular cross section where the blade 32 is attached to it, there are other shapes of blade actuators, such as round, half-round, square, etc. that are used on saw models other than the one used to derive the design of the present saw. Such a variety of actuator shapes will influence design and manufacturing considerations such as whether to make the actuator a one-piece part, or a multi-piece part assembled by a process such as welding. The other references in this view were described in FIG. 1.

Description—FIG. 3

Although the part of the blade actuator 44 that the typical layperson sees is a shaft exiting the forward housing 26 of the saw, FIG. 3 is an orthogonal view of a flat side of the entire blade actuator 44 showing its camming slot 46 that is instrumental in converting the rotary motion of the motor to linear reciprocating motion at the tip of the blade actuator 44.

Description—FIG. 4

FIG. 4 is a view of the left side of the preferred embodiment of the present saw showing a new universal blade 66 installed on the left side of the saw. The blade is positioned by placing its shank between grooves in the ends of a new blade actuator 54 and a blade clamp 58, which will be shown and described in later figures. The blade clamp 58 is secured by a clamping screw 56 on each of its ends. The saw's “rocking shoe” 60 has a pivot slot 62 on each of its sides that allow the shoe 60 to be pivoted around pivot studs 64 that also serve to mount the shoe 60 to a shoe mounting bracket 52. Since the present saw does not have provisions for gripping it by its forward housing 48, it has a downward projecting forward handle 50 instead, which fits underneath the saw's forward housing 48, so that flush cuts may be made on either side of the saw. Ref. 10 will be described in detail in FIG. 10. All other references in this view have already been described in earlier figures.

Description—FIG. 5

FIG. 5 is an enlarged, full orthogonal view of the new blade actuator 54 for the present saw. It has blade grooves 78 for accommodating the shank of the blade 66 and threaded mounting holes 80 to be used in conjunction with the clamp 58 and the screws 56 to secure the blade 66 into position. How the actuator 54 is formed to position the blade's top row of teeth above the plane of the top of the saw can be appreciated by studying the shape of this part in FIG. 4. The same camming slot 46 that was shown in FIG. 3 is used in this new actuator.

Description—FIGS. 6 and 7

FIG. 6 shows the new “rocking shoe” 60 detached from the shoe mounting bracket 52. The end of the bracket 52 is contoured with a radius that conforms to the radius of the inside of the face of the shoe 60, so that the shoe may be rotated inside the pivot slot 62 around the shouldered pivot stud 64 that will be secured by riveting it into the stud mounting holes 68, which are on each side of the bracket 52. FIG. 7 shows the assembled shoe and bracket assembly 65. The arrow references are to FIGS. 8 and 9.

Description—FIG. 8

FIG. 8 is a view of the shoe and bracket assembly 65 taken along line 8-8 of FIG. 7. The bracket 52 has a shoe locking flange 70 on its curved end for positioning purposes, as will be seen in FIG. 9. The lip 70 has two threaded holes 72 in it that allow screws 74, shown in FIG. 9, to be placed through the shoe adjustment slots 76 and into the threaded holes 72.

Description—FIG. 9

FIG. 9 is a view of the shoe and bracket assembly 65 looking at its face along line 9-9 in FIG. 7. The locking slots 76 are countersunk, so that they receive the adjustment screws 74 flush with the face of the shoe 60. The other reference numerals in this view were described in earlier figures.

Description—FIGS. 10 and 11

FIG. 10 is an enlarged view of a front section of the present saw taken along line 10-10 of FIG. 4. This view, in conjunction with FIG. 11 shows how the shank 84 of the blade and shank assembly 82 is positioned in the blade actuator grooves 78 and the blade clamp grooves 86 and then tightened by the clamp screws 56. The angle between the blade actuator 54 and the blade clamp 58 has been exaggerated in these views to provide detail. The dashed circle 11 refers to FIG. 11, which is a magnified view providing even more detail concerning the arrangement of the blade and shank assembly 82, the blade actuator 54 and the blade clamp 58.

Description—FIGS. 12 and 13

FIG. 12 shows how the blade and shank assembly 82 consists of a shank 84 welded to the blade 66 that has a plurality of teeth on both its leading edge and its trailing edge. This makes the blade and shank assembly 82 universial in the sense that it can be used on either side of the present saw. It also enables the user to cut with the saw in either direction. Since there are no bends associated with achieving this offset blade design, it is less susceptible to breakage from stress hardening. A further advantage to this design is that it enables a manufacturer to determine the amount that the shank 84 is offset from the blade 66 by controlling the thickness of the thicker (lower part in this view) part of the shank 84. This assembly may also be manufactured as a one piece part.

Operation of the Preferred Embodiment

When using the present saw to cut into a workpiece, the blade can be advanced in an infinite number of directions, depending on whether the saw is being used to cut overhead such as a ceiling, down below such as a floor, down or up a perpendicular surface such as a wall, etc. To minimize confusion, the operating instructions are given in respect to the view of the present saw shown in FIG. 4. If I refer to pulling the saw into the workpiece, it means moving the saw in a direction that causes the bottom row of the teeth of the blade 66 to cut the workpiece. If I refer to pushing the saw into the workpiece, it means moving the saw in a direction that causes the top row of teeth of the blade 66 to cut the workpiece.

To install the blade on either side of the saw, the user loosens the two clamping screws 56 and inserts the shank 84 of the blade & shank assembly 82 into the appropriate slots in the blade actuator 54 and the blade clamp 58. Both screws 56 are then tightened to secure the blade 66 in place. The combined depths of the clamp slot 86 and the actuator slot 78 is slightly less than the width of the mounting stem of the blade shank 84 to ensure secure attachment of the blade & shank assembly 82.

To make “flush with” cuts or cuts without regard to flushness, which will usually be the most common requirement, the tip of the shoe 60 should be positioned so that it is above the plane of the teeth of the blade 66 as shown in FIG. 4. This is done by loosening the two locking screws 74 shown in FIG. 9, rotating the shoe 60 into position, then tightening the screws 74. The saw can now be used to cut by either pushing or pulling it into the workpiece, and the leading surface of the shoe will stabilize the saw when starting a cut at the edge of a workpiece.

To make “flush to” cuts, the shoe 60 should be adjusted as above to initially start the cut, since it will need to provide stability for the saw when starting the cut at the edge of a workpiece. Once the cut has sufficienly started, the shoe 60 should be adjusted so that its tip is rotated below the plane of the teeth of the blade 66. The saw can now be used to cut the workpiece “flush to” an intersecting perpendicular surface such as a wall.

The forward handle 50 has a knob on its lower end to provide a sure grip for cutting with the saw while pulling it into a workpiece without the user's hand slipping off.

Situations may arise in which the user may prefer using a single-edge blade & shank assembly (not shown). Such situations could arise when the saw is being used to cut in close proximity of plastic pipes or electrical insulation that the user doesn't want to inadvertently sever, for example. Should a manufacturer choose to provide such a blade, its design would be obvious.

Except for the shoe adjustment and positioning the blade on either side of the saw, the method of using the present saw is the same as with a conventional hand-held reciprocating saw.

Descriptions of the Alternate Embodiment

As was mentioned earlier in this application, the drawing figures and descriptions that are being submitted apply to just one conventional reciprocating saw model at has been used as an example of how such a saw can be modified into the present saw. There is a variety of other reciprocating saw designs that this invention applies to as well. Since the design of the shoe often is critical in designing a flush cutting device, and the fact that some users or manufacturers may prefer one shoe design over another, an alternate shoe design; which detracts in no way from the spirit and scope of this invention; is being disclosed. For ease of cross-referencing, figure numbers for this alternate embodiment are the same as those for comparable views of the preferred embodiment, but have been suffixed by the alphabet “A”.

Description—FIG. 4A

FIG. 4A schematically shows the alternate embodiment of the present saw with the blade 66 installed on the left side of the saw and a new “sliding shoe” 88 adjusted so that its tip is positioned below the plane of the top row of teeth of the blade 66. The shoe 88 of this embodiment has a flat face and is moved either up or down to effect adjustment of the position of its tip relative to the top row of teeth of the blade 66. This positioning capability is relevent primarily to the saw's ability to make “flush to” cuts starting from the edge of a workpiece as was mentioned in the “operation” of the preferred embodiment. The shoe 88 has a new mounting bracket 96 and a shoulder stud 94 which mounts it in a vertical positioning slot 90. Nothing else was changed in this view of the present saw, but many of the reference numerals shown in the preferred embodiment have been included in this view for ease of cross-referencing.

Description—FIGS. 6A and 7A

FIG. 6A shows the new “sliding shoe” 88 detached from the shoe mounting bracket 96. The end of the bracket 96 is flat and parallel to the inside of the face of the shoe 88, so that it can move up or down in the slot 90 when coupled with it using a shouldered stud 94 that will be secured by riveting it into the stud mounting holes 92, which are on each side of the bracket 96. FIG. 7A shows the assembled shoe and bracket assembly 106. The arrow references are to FIGS. 8A and 9A.

Description—FIG. 8A

FIG. 8A is a view of the shoe and bracket assembly 106 taken along line 8A-8A of FIG. 7A. The bracket 96 has a flange 98 on its end that enters the shoe 88 for positioning purposes, as will be described in FIG. 9A. The flange 98 has two threaded holes 102 in it that allow screws 104, shown in FIG. 9A, to be placed through the shoe adjustment slots 100 and into the threaded holes 102.

Description—FIG. 9A

FIG. 9A is a view of the shoe and bracket assembly 106 looking at its face along line 9A-9A of FIG. 7A. The adujstment slots 100 are countersunk, so that they receive the adjustment screws 104 flush with the face of the shoe 88. The other reference numerals in this figure were described in earlier figures.

Operation of the Alternate Embodiment

The operation of this embodiment of the present saw is identical to that of the preferred embodiment, except that the shoe 88 is adjusted by sliding it up or down into position, rather than rotating it into position.

### CONCLUSION

Accordingly, the reviewer will see that there are significant advantages of the proposed flush cutting reciprocating saw over other such saws of the prior art. The presence of a clear need for a saw using the present saw's flush cutting capability and the absence of such a saw on the market suggests that innovations such as the “rocking shoe”, the “sliding shoe”, the “T”-shaped blade actuator and the double-edged offset shank blade were nonobvious to practicioners of the prior art. The present saw, in addition to its exclusive flush-cutting capability, can be used in practically any application that reciprocating saws of conventional design can be used in.

Development, manufacturing and distribution costs of this product are minimized by modifying an existing saw design that has already been developed and tested and, in addition, the present reciprocating saw can be built and distributed by manufacturers of conventional reciprocating saws that already have the sales force and distribution channels established.

It will be understood that while the form of the invention herein shown and described constitute preferred embodiments of the invention, it is not intended to illustrate all possible forms of the invention. It will also be understood that the words used throughout this application are words of description rather than words of limitation and that various changes may be made without departing from the spirit and scope of the invention herein disclosed and claimed.

What is claimed is:

1. An electrically powered reciprocating saw comprising:
a housing;
an electric motor within said housing;
a means, also within said housing, by which the rotary motion of said motor is converted to linear motion at an actuator that reciprocates a saw blade in a plane that is horizontal to the plane of the longitudinal centerline of said saw's housing;
said electric motor may be designed to use either household electric current or batteries as a source of power;
means by which said reciprocating saw can make any cut on a workpiece that can be made by reciprocating saws of conventional design.

2. The electrically powered reciprocating saw of claim 1 that is capable of cutting a workpiece flush with and flush to a raised surface positioned in an intersecting perpendicular plane comprising:
a means enabling the blade assembly of said reciprocating saw to be operably attached to either side of said reciprocating saw in a manner that enables the saw to perform flush cuts along a raised surface positioned in an intersecting perpendicular plane that is within or beyond the plane of either side of the saw;
an adjustable shoe that can have its leading surface positioned either beyond or behind the plane of the blade's forward cutting teeth;
a shoe with a contoured face that enables it to maintain tangency and contact with a workpiece while the saw's body is pivoted up or down in respect to the workpiece during cutting;
a means enabling the blade and shank assembly of said reciprocating saw to be operably attached in a manner that enables the saw to cut flush up to a raised surface positioned in an intersecting perpendicular plane.

3. The reciprocating saw of claim 1 wherein said saw blade is an offset shank cutting blade comprising a plurality of teeth on both its leading edge and its trailing edge;
said reciprocating saw cutting blade may be used on either the left side or the right side of said reciprocating saw;
said reciprocating saw cutting blade has an offset shank that enables the cutting teeth of said cutting blade to operate in a plane outside the plane of either side of the saw's housing;
the offset of the shank of said reciprocating saw cutting blade, in respect to the cutting blade is goverened by the thickness of the shank at the point where it is affixed to the blade;
said offset shank reciprocating saw cutting blade can be manufactured as a one piece part.
